(19) United States
(12) Patent Application Publication
(10) Pub. No.: US 2026/0329493 A1
(43) Pub. Date: Oct. 22, 2026

(54) INFORMATION PROCESSING APPARATUS, CONTROL METHOD, AND STORAGE MEDIUM

(71) Applicant: CANON KABUSHIKI KAISHA, Tokyo (JP)

(72) Inventor: AKIHIRO YASUDA, Saitama (JP)

(21) Appl. No.: 19/644,335

(22) Filed: Apr. 10, 2026

(30) Foreign Application Priority Data
Apr. 21, 2025 (JP) 2025-069989

(51) Int. Cl. G06F 3/12

(52) U.S. Cl. CPC G06F 3/1232; G06F 3/1205; G06F 3/1208; G06F 3/1225; G06F 3/1256; G06F 3/1257

(57) ABSTRACT

A non-transitory computer-readable storage medium storing an application program which causes an information processing apparatus to perform a control method, the application program cooperating with a standard driver, the control method includes acquiring capability information, displaying a print setting screen configured to receive a print setting from a user, displaying, on the print setting screen, a first print setting included in the capability information based on information related to the print setting, and displaying, on the print setting screen, a second print setting included in the capability information based on information stored in advance in the application program.

### BACKGROUND

### Field of the Technology

The present disclosure relates to an information processing apparatus, a control method, and a storage medium.

### Description of the Related Art

There is a known configuration in which a printer driver installed on a host computer is used as control software for a printing device, and print instructions are issued to the printing device connected to the host computer. The host computer has an operating system (OS), which is basic software, installed thereon, and the printer driver, which is configured in accordance with specifications defined by the OS, is called by the OS to operate. A vendor that provides a printing device can provide a method of issuing print instructions to the printing device using the OS by providing a printer driver in compliance with the specifications of the OS.

In recent years, Windows provides a standard class driver (hereinafter, also referred to as a “standard driver”) that can be commonly used for printing devices provided by a plurality of vendors. Such a standard driver is included in the OS package and can be readily used by connecting a desired printing device to a host computer. Thus, it is not necessary to separately install a model-specific printer driver suitable for a printing device, providing high convenience.

Further, the standard driver is configured so that printing functions can be specified in accordance with PrintCapabilities generated based on information acquired from a connected printing device. This makes it possible for the user of the standard driver to specify printing functions corresponding to the capabilities of the connected printing device, even though the user uses the single standard driver.

The standard driver can be associated with an application for function extension (hereinafter, also referred to as an “extension application”). The extension application can be provided by the vendor that provides the printing device. By editing Print Device Capabilities (PDC) generated by the standard driver, the extension application can provide functions (extended functions) that cannot be carried out by the standard driver alone.

Japanese Patent Laid-Open No. 2019-74906 describes a technique of providing a graphical user interface (GUI), which, for example, displays a print preview screen, using an extension application. That technique using the standard driver and the extension application allows the user to view an image of a print result on a print preview screen displayed by the extension application before the user performs printing with a printing device.

However, there is a need for further improvement in convenience of such an extension application as described in Japanese Patent Laid-Open No. 2019-74906.

### SUMMARY

According to an aspect of the present disclosure, a non-transitory computer-readable storage medium storing an application program which causes an information processing apparatus to perform a control method, the application program cooperating with a standard driver, the control method includes acquiring capability information, displaying a print setting screen configured to receive a print setting from a user, displaying, on the print setting screen, a first print setting included in the capability information based on information related to the print setting, and displaying, on the print setting screen, a second print setting included in the capability information based on information stored in advance in the application program.

Features of the present disclosure will become apparent from the following description of embodiments with reference to the attached drawings. The following description of embodiments is described by way of example.

### BRIEF DESCRIPTION OF THE DRAWINGS

FIG. 1A is a block diagram illustrating a hardware configuration of a printing system. FIGS. 1B and 1C are each a diagram illustrating a configuration of the printing system.

FIG. 2 illustrates an example in which a print setting screen of an extension application is displayed from a desktop application.

FIG. 3 illustrates an example in which the print setting screen of the extension application is displayed from a Universal Windows Platform (UWP) application.

FIG. 4 illustrates an example in which a print setting screen of the extension application is displayed from a control panel provided by an operating system of an information processing apparatus.

FIG. 5 illustrates an example in which a print setting screen of the extension application is displayed from the control panel provided by the operating system of the information processing apparatus.

FIG. 6 illustrates an example of a screen configuration of a print setting screen provided by the extension application and descriptions of objects and controls.

FIGS. 7A and 7B illustrate an example of a print setting screen provided by the extension application.

FIGS. 8A to 8C each illustrate an example of a print setting screen provided by the extension application.

FIGS. 9A to 9D illustrate examples of controls on a print setting screen provided by the extension application.

FIG. 10 illustrates an example in which a main screen is displayed from a print setting screen provided by the extension application.

FIG. 11 illustrates an example of a model name of a printing device displayed on a print setting screen provided by the extension application.

FIG. 12 illustrates printing functions provided by the extension application and a display order of the printing functions.

FIG. 13 illustrates printing functions that reference resources (information) stored in the extension application.

FIG. 14 illustrates setting items that reference resources (information) stored in the extension application and a display order of the setting items.

FIG. 15A illustrates setting items that reference resources (information) stored in the extension application with a printing device as a prosumer inkjet printing device, and a display order of the setting items.

FIG. 15B illustrates setting items that reference resources (information) stored in the extension application with the printing device as the prosumer inkjet printing device, and a display order of the setting items.

FIG. 15C illustrates setting items that reference resources (information) stored in the extension application with the printing device as the prosumer inkjet printing device, and a display order of the setting items.

FIG. 16A illustrates setting items that reference resources (information) stored in the extension application with a printing device as an electrophotographic printing device, and a display order of the setting items.

FIG. 16B illustrates setting items that reference resources (information) stored in the extension application with the printing device as the electrophotographic printing device, and a display order of the setting items.

FIG. 16C illustrates setting items that reference resources (information) stored in the extension application with the printing device as the electrophotographic printing device, and a display order of the setting items.

FIG. 17A illustrates setting items that reference resources (information) stored in the extension application with the printing device as the prosumer inkjet printing device, and a display order of the setting items.

FIG. 17B illustrates setting items that reference resources (information) stored in the extension application with the printing device as the prosumer inkjet printing device, and a display order of the setting items.

FIG. 17C illustrates setting items that reference resources (information) stored in the extension application with the printing device as the prosumer inkjet printing device, and a display order of the setting items.

FIG. 17D illustrates setting items that reference resources (information) stored in the extension application with the printing device as the prosumer inkjet printing device, and a display order of the setting items.

FIG. 18 illustrates setting items that reference resources (information) stored in the extension application with the printing device as the electrophotographic printing device, and a display order of the setting items.

FIGS. 19A and 19B illustrate examples of preview images displayed on a print setting screen provided by the extension application.

### DESCRIPTION OF THE EMBODIMENTS

An embodiment of the present disclosure will now be described in detail with reference to the attached drawings. The following embodiments are not intended to limit the present disclosure pertaining to the scope of the claims, and not all of the combinations of features described in the embodiment are necessarily essential to the solution provided by the present disclosure.

Further, like reference numerals refer to like components, and description thereof will be omitted.

### Hardware Configuration of Printing System

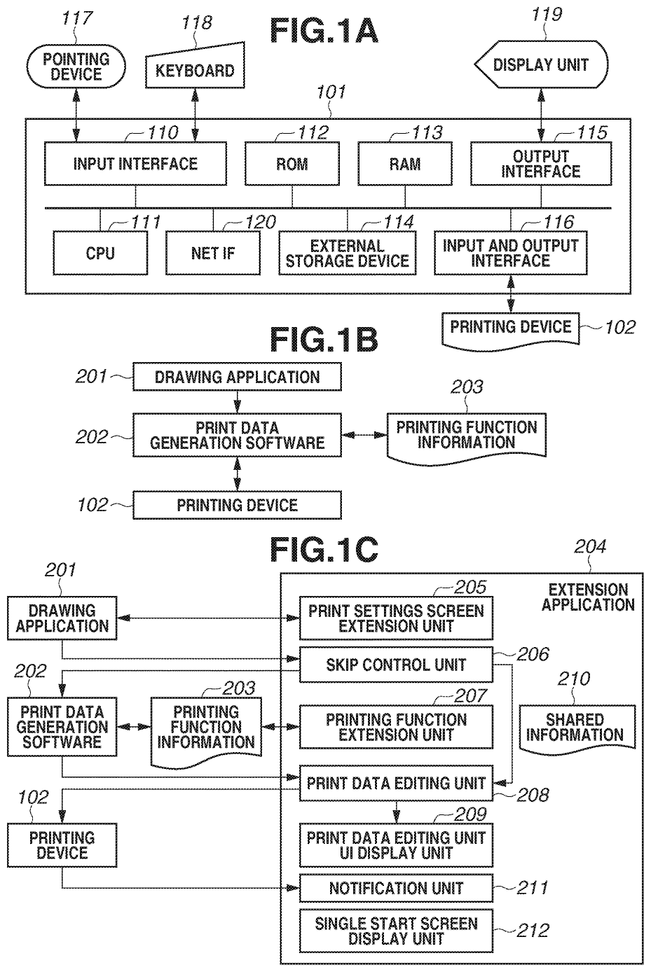

FIG. 1A is a block diagram illustrating a hardware configuration of a printing system. In FIG. 1A, a host computer 101, which is an example of an information processing apparatus, includes an input interface 110, a central processing unit (CPU) 111, a read-only memory (ROM) 112, a random access memory (RAM) 113, an external storage device 114, an output interface 115, and an input and output interface 116.

An input device, such as a keyboard 118 or a pointing device 117, is connected to the input interface 110, and a display device, such as a display unit 119, is connected to the output interface 115.

A network interface (NETIF) 120 performs control to transfer data with an external device via a network.

The ROM 112 stores an initialization program. The external storage device 114 stores application programs, an operating system (OS), print data generation software, and various other types of data. The RAM 113 is used as a working memory or the like when the various programs stored in the external storage device 114 are executed, enabling the various programs to run in the host computer 101.

In the present embodiment, the CPU 111 performs processing according to the procedures of programs stored in the ROM 112 to execute functions described below in the host computer 101. A printing device 102 is connected to the host computer 101 via the input and output interface 116.

In the present embodiment, the host computer 101 and the printing device 102 are configured as separate devices, but the host computer 101 and the printing device 102 may be configured as a single information processing apparatus. Further, an example will be described of the printing device 102 as an inkjet printer that performs printing by discharging ink onto paper. However, printing may be performed using another method (for example, an electrophotographic method). The host computer 101 may be a desktop personal computer, a smartphone, or a laptop computer.

### Configuration of Printing System Centered on Software

FIGS. 1B and 1C are each a schematic diagram illustrating a configuration of the printing system centered on software. In this case, the following description is based on the assumption that the printing system uses the host computer 101, which has Microsoft Windows as its OS. FIG. 1B is a diagram illustrating a typical configuration in which the extension application 204 is not associated with print data generation software 202 and the printing device 102.

A drawing application 201 is software that creates content (drawing data) to be printed. For example, the drawing application 201 corresponds to a document creation application or a spreadsheet application. In response to receiving a print request from the user, the drawing application 201 issues a print instruction to the OS. The print instruction includes print setting information for instructing the print data generation software 202 and the printing device 102 to operate. The print setting information is also referred to as PrintTicket (hereinafter, referred to as “PT”).

The drawing application 201 is capable of causing a print setting screen, which is provided by either the print data generation software 202, the OS, or the drawing application 201, to be displayed in order to output print setting information. The print setting screen includes objects (hereinafter, also referred to as “control items”) indicating configurable printing functions and control items indicating setting values therefor according to capability information (information that can be set as print settings) acquired from the print data generation software 202. The capability information is also referred to as PrintCapabilities (hereinafter, referred to as “PC”).

The print data generation software 202 determines the PC based on printing function information 203. The printing function information 203 is data indicating all configurable printing functions, setting values therefor, and mutually exclusive relationships between the setting values. The printing function information 203 is also referred to as Print Device Capabilities (PDC).

The PDC 203, which is included in a configuration file of the print data generation software 202, is arranged in the external storage device 114 as an unmodifiable file. Alternatively, the PDC 203 can be dynamically generated by the print data generation software 202. In this case, the generated PDC 203 is editable. Specifically, the print data generation software 202 or the OS can be configured to acquire attribute data about the printing device 102 from the printing device 102 to generate the PDC 203 based on the attribute information in the acquired attribute data.

The attribute data about the printing device 102 is acquired by a Get-Printer-Attributes operation of Internet Printing Protocol (IPP) being issued to the printing device 102. The response to Get-Printer-Attributes includes attribute information indicating functions that can be specified in the printing device 102 (capabilities of the printing device) and setting values related to the attribute information. This response is stored in the RAM 113.

This configuration makes it possible for the print data generation software 202 to allow the user to specify the printing functions available on each connected printing device 102 depending on the connected printing device 102. Thus, even when a printing device having a different function or a printing device developed by a different vendor is connected, the print data generation software 202 can be configured so that the user can specify printing functions available on the connected printing device 102.

In the present embodiment, a configuration using, as the print data generation software 202, an IPP Class Driver or an UP Class Driver included in Windows will be described.

The IPP Class Driver and the UP Class Driver, which are printer drivers that execute printing processing in accordance with the specifications of a standard printing protocol referred to as IPP, are included in the OS package. In other words, the IPP Class Driver and the UP Class Driver are printer drivers provided by the OS provider.

The IPP Class Driver and the UP Class Driver are not printer drivers specific to a model of the printing device 102, but are standard class drivers capable of transmitting print data to a plurality of different printing devices provided by a plurality of different manufacturers. The IPP Class Driver is a standard driver that performs local printing in accordance with the above specifications, and the UP Class Driver is a standard driver that performs cloud printing.

In the case of performing cloud printing using the UP Class Driver, the print data is not transmitted directly to the printing device 102, but is transmitted to the printing device 102 via a cloud printing-related service, and then printing is performed by the printing device 102. Further, the IPP Class Driver and the UP Class Driver obtain capability information about the connected printing device 102 to generate the printing function information 203 based on the capability information so that the user can specify printing functions supported by the connected printing device 102.

The OS generates intermediate data (also referred to as input data) based on the print instruction output from the drawing application 201 and passes the intermediate data to the print data generation software 202. The data output by the drawing application 201 for printing is data in Graphic Device Interface format (GDI format data) or in Extensible Markup Language (XML) Paper Specification format (XPS format data).

In the case of using the print data generation software 202, if the data output by the drawing application 201 is GDI format data, the OS converts the GDI format data output by the drawing application 201 into XPS format data. Then, the OS passes the converted XPS format data as intermediate data to the print data generation software 202. If the data output by the drawing application 201 is XPS format data, the OS passes the XPS format data as intermediate data to the print data generation software 202.

The intermediate data includes drawing data, which is information about an image to be formed on a sheet, and print setting information set by the user.

The print data generation software 202 converts the acquired intermediate data into print data interpretable by the printing device 102 and transmits the print data to the printing device 102. The print data includes drawing data, which is information about an image to be formed on a sheet, and print setting attribute information (attribute information that specifies print settings) generated based on the print setting information set by the user. The print setting attribute information includes attribute information that indicates functions specifiable by the printing device 102 (capabilities of the printing device 102) and setting values related to the attribute information.

The printing device 102 performs printing on a sheet based on the print data transmitted from the print data generation software 202. At this time, the printing device 102 forms on a sheet the drawing data included in the print data in accordance with the print setting attribute information included in the print data. The print setting attribute information includes attribute information and setting values for specifying print quality (image-quality priority, speed priority, or the like), two-sided printing, and the like. For example, when the print setting attribute information includes attribute information specifying two-sided printing, the printing device 102 performs two-sided printing.

FIG. 1C is a diagram illustrating a configuration in which the extension application 204 is associated with the print data generation software 202 and the printing device 102. The configurations and processes that are not specifically described below are the same as those in FIG. 1B.

The extension application 204, which is software for extending the functions of the print data generation software 202, is not included in (packaged with) the OS. Thus, the user needs to operate the host computer 101 to download and install the extension application 204 from a server via the Internet.

Alternatively, the extension application 204 may be automatically installed in response to the printing device 102 being connected to the host computer 101. Specifically, when the printing device 102 is connected to the host computer 101, the OS acquires device identification information from the printing device 102. The OS may download and install the extension application 204 corresponding to the acquired device identification information from a server via the Internet. Thus, the print data generation software 202 and the extension application 204 are stored in the host computer 101 as separate files.

The print data generation software 202 and the extension application 204 may be updated to newer versions, and the update processes are also performed at different timings. In other words, the timing at which the host computer 101 acquires the print data generation software 202 differs from the timing at which the host computer 101 acquires the extension application 204. Further, the trigger for the host computer 101 to acquire the print data generation software 202 differs from the trigger for the host computer 101 to acquire the extension application 204.

Further, with the extension application 204 installed, the OS associates the extension application 204 with the print data generation software 202 and the printing device 102.

The extension application 204 in the present embodiment includes a print setting screen extension unit 205, a skip control unit 206, a printing function extension unit 207, a print data editing unit 208, a notification unit 211, and a print data editing unit user interface (UI) display unit 209. The extension application 204 also includes shared information 210 that can be commonly accessed by each unit. The shared information 210 is actually a file saved in the external storage device 114 or information stored in the RAM 113.

The extension application 204 is capable of freely writing information to, and reading information from, the shared information 210 by using an Application Program Interface (API) provided by the OS. Further, the shared information 210 is allocated as an area in which information can be stored exclusively for the application, and is also capable of storing information other than the attribute data about the printing device 102.

The shared information 210 is different from the PDC 203 generated by the print data generation software 202 or the OS to specify printing functions available on the connected printing device 102.

The extension application 204 may terminate its operation each time processing by each unit is completed. In this case, the OS activates the extension application 204 each time a request to use each unit is received. Another configuration is also possible. For example, the OS terminates the operation of the extension application 204 when the processing by the print setting screen extension unit 205 is completed. Alternatively, the OS may keep the extension application 204 running even after processing by the skip control unit 206 is completed.

The extension application 204 may cancel processing during each unit execution of the processing. If the processing is canceled, the job being processed in the print queue is deleted by the OS.

In this specification, an OS print module (which may include the print data generation software 202) may be referred to as print software. In the present embodiment, processing executed by the information processing apparatus in response to instructions from the print data generation software 202 may be executed in response to instructions from the print software or the OS. Similarly, operations performed by the extension application 204 on the print data generation software 202 may be operations performed on the print software or the OS.

In response to receipt of a print request from the user, the drawing application 201 issues a print instruction to the OS. In this configuration, similar to the configuration of FIG. 1B, the drawing application 201 can cause the print setting screen to be displayed. In this configuration, the print setting screen provided by the extension application 204 is displayed. Specifically, the print setting screen provided by the print setting screen extension unit 205 included in the extension application 204 is displayed.

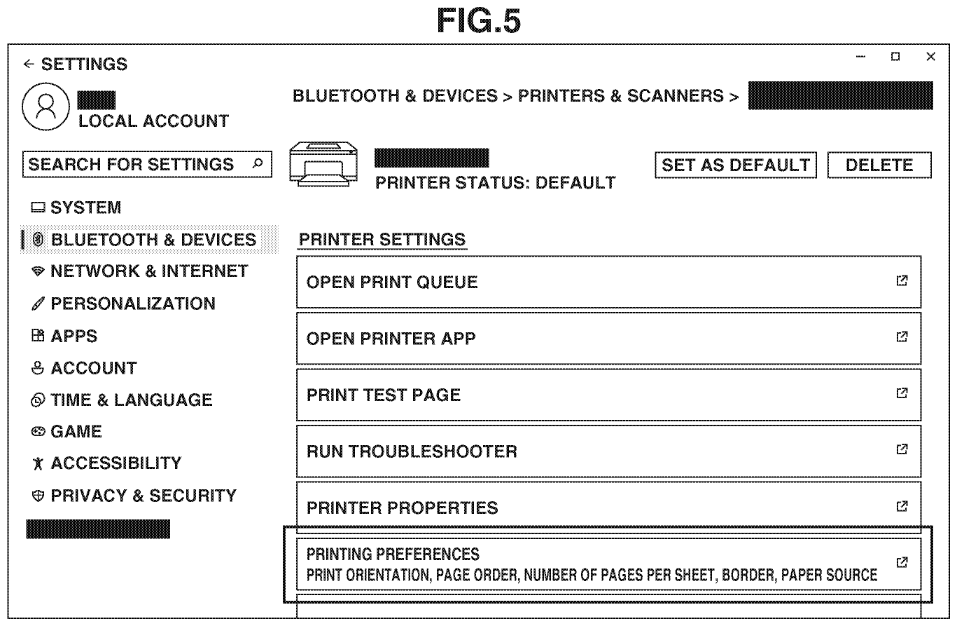

Whether the print setting screen provided by the print setting screen extension unit 205 is displayed depends on the user's operation. For example, a case will be described in which the drawing application is a document creation application or a spreadsheet application. In this case, the print setting screen provided by the print setting screen extension unit 205 is displayed by the user pressing a property setting button displayed on the print setting screen provided by the document creation application or the spreadsheet application. Details of the print setting screen extension unit 205 will be described below with reference to FIG. 5.

When the drawing application 201 receives a print request from the user and issues a print instruction to the OS, the OS activates the skip control unit 206. The skip control unit 206 controls whether to skip the processing by the print data generation software 202. The skip control unit 206 cannot acquire intermediate data or print setting information. After the skip control processing performed by the skip control unit 206, the OS generates intermediate data based on the print instruction output from the drawing application 201, and the intermediate data is passed to the print data generation software 202.

If no skip control is performed by the skip control unit 206, the intermediate data is processed by the print data generation software 202 into print data interpretable by the printing device 102, and is then passed to the print data editing unit 208.

On the other hand, if the processing by the print data generation software 202 is skipped, the intermediate data is passed to the print data editing unit 208 without being processed by the print data generation software 202. This enables the print data editing unit 208 to process the intermediate data.

Examples in which the processing by the print data generation software 202 can be skipped include a case where a scaling process is to be performed at the print data editing unit 208. The intermediate data can retain data in a vector format, and thus degradation during scaling is reduced. Thus, in such a configuration in which the print data generation software 202 outputs images in a raster format, it is generally desirable to skip the processing by the print data generation software 202 and to process the intermediate data at the print data editing unit 208.

The print data editing unit 208 edits the intermediate data that is passed from the print data generation software 202 or the print data processed by the print data generation software 202. For example, in the case of layout printing as the editing content, the print data editing unit 208 changes the layout of the intermediate data or the print data based on the print setting information for layout printing received from the OS.

The print data editing unit 208 is capable of requesting the OS to display a UI screen on the display unit 119. In response to the request from the print data editing unit 208, the OS activates the print data editing unit UI display unit 209. The print data editing unit UI display unit 209 is capable of displaying, for example, layout results of the intermediate data or the print data as a preview screen on the display unit 119.

With the UI screen kept open by the print data editing unit UI display unit 209, the print data editing unit 208 does not transmit print data to the printing device 102. By closing the UI screen displayed by the print data editing unit UI display unit 209, the print data editing unit 208 executes the transmission processing for the print data.

After the print data editing unit 208 edits the print data, the print data is passed to the printing device 102 via the OS. The printing device 102 performs printing on a sheet based on the received print data. If the skip control unit 206 skips the processing by the print data generation software 202, the print data editing unit 208 may convert the received intermediate data into print data interpretable by the printing device 102. Alternatively, the conversion from the intermediate data to the print data may be performed using a function provided by the OS.

The extension application 204 includes the printing function extension unit 207. The printing function extension unit 207 is capable of editing the PDC 203 generated by the print data generation software 202 or the OS. This enables the printing function extension unit 207 to add, for example, functions provided by the extension application 204, to add functions that are supported by the printing device 102 but are not supported by the print data generation software 202, and to add exclusive relationships between setting values of printing functions.

The OS activates the printing function extension unit 207 when the extension application 204 is first associated with the printing device 102 and the print data generation software 202. Further, the OS may activate the printing function extension unit 207 at another timing, such as at the OS startup. In this manner, in a case where an optional device (for example, a finisher) is added to the printing device 102 at a later time and printing-related functions are expanded, the printing function extension unit 207 is capable of detecting the expanded functions to add the expanded functions to the PDC 203.

Further, the extension application 204 includes the notification unit 211. The notification unit 211 is capable of displaying a notification to the user in response to the occurrence of an error in the printing device 102.

For example, when an out-of-paper error occurs in the printing device 102, the print data generation software 202 detects the error, and the OS causes the display unit 119 to display a message using a notification function referred to as a toast notification. When the user presses the toast notification, the OS calls the notification unit 211 of the extension application 204 to display a UI screen of the notification unit 211. The UI screen of the notification unit 211 is capable of displaying, for example, a detailed message about the out-of-paper error and instructions on how to load sheets.

Further, once the extension application 204 transmits print data to the printing device 102, the extension application 204 cannot display on the screen a guide or other information associated with the print data during processing by each unit.

Further, the configuration of the extension application 204 for implementing the present embodiment is not limited to a configuration that includes all of the above-described functions (units), and may have only some of the functions or other functions. The extension application 204 can be simply referred to as printing software. As described above, the extension application 204 can be regarded as including at least one of the print setting screen extension unit 205, the skip control unit 206, the printing function extension unit 207, the print data editing unit 208, the print data editing unit UI display unit 209, and the notification unit 211.

### Start of Extension Application

The print setting screen provided by the extension application 204 is activated by an operation to open the print setting screen provided by the print data generation software 202 being performed from a desktop application or a Universal Windows Platform (UWP) application.

The desktop application is, for example, a “Win32/64 application” or a “.NET application”. The UWP application runs on the OS. The UWP application is distributed through the Windows Store, and runs in a different execution environment from that of the desktop application.

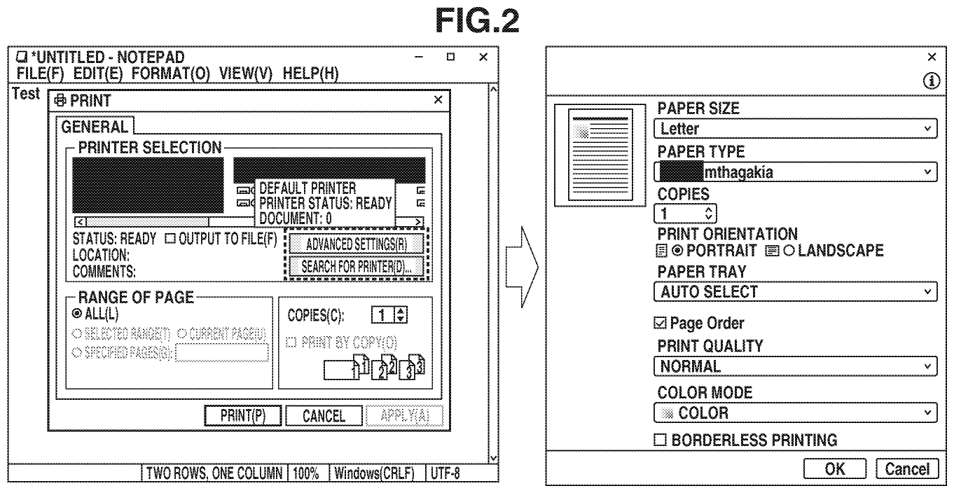

In the case of using a desktop application, as illustrated in FIG. 2, the print setting screen of the extension application 204 is activated in response to an advanced settings button being pressed in a common print dialog (CPD), which is opened when a print instruction is issued from the desktop application. The desktop application is also capable of opening the print setting screen of the print data generation software 202 without going through a CPD. Whether to go through the CPD depends on the configuration of the desktop application.

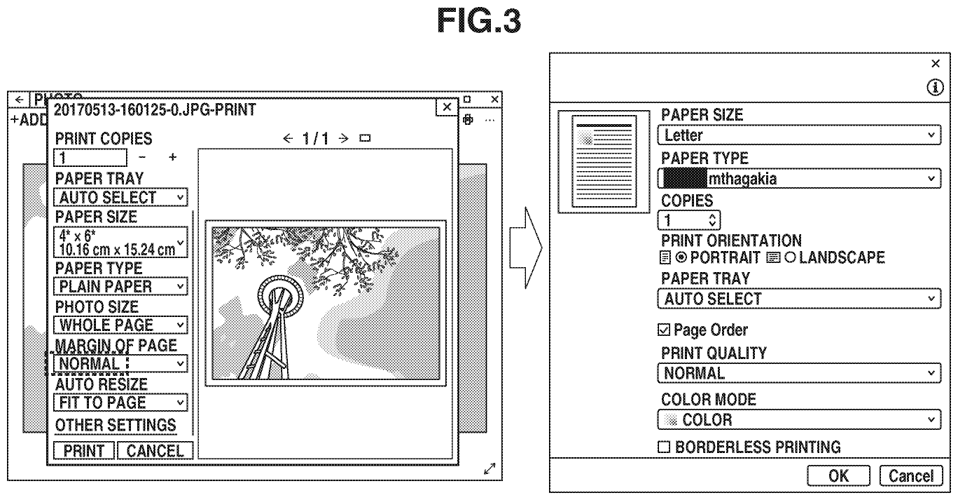

In the case of using a UWP application, as illustrated in FIG. 3, the print setting screen of the extension application 204 is activated in response to an “other settings” button being pressed in a modern print dialog (MPD), which is opened when a print instruction is issued from the UWP application.

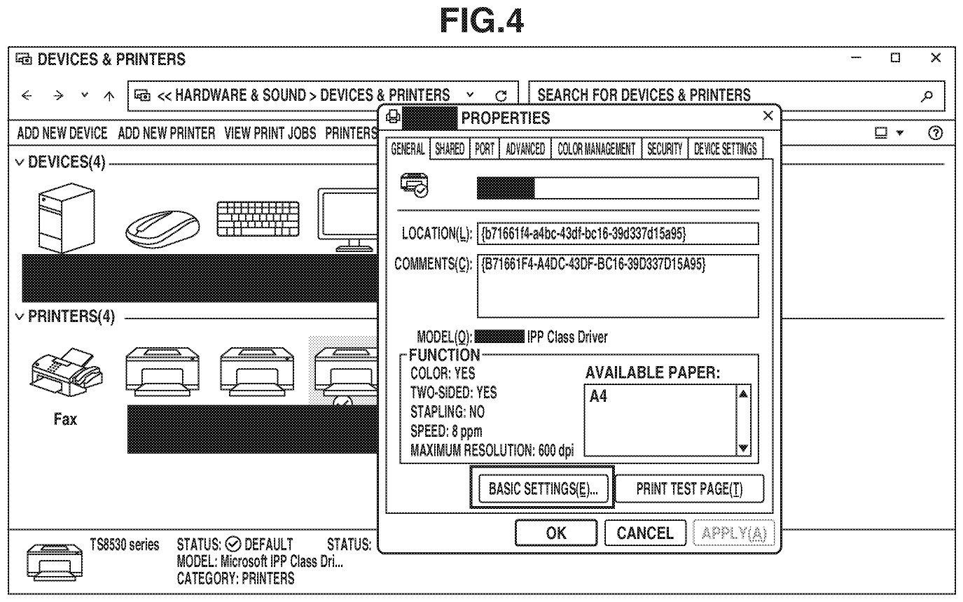

As illustrated in FIG. 4, when the print setting screen is opened from Devices and Printers in the control panel provided by the OS of the information processing apparatus, the print setting screen of the extension application 204 is activated. As illustrated in FIG. 5, when the print setting screen is opened from Printers and Scanners in the settings application in the control panel provided by the OS of the information processing apparatus, the print setting screen of the extension application 204 is activated.

### Screen Configuration of Print Setting Screen Provided by Extension Application 204

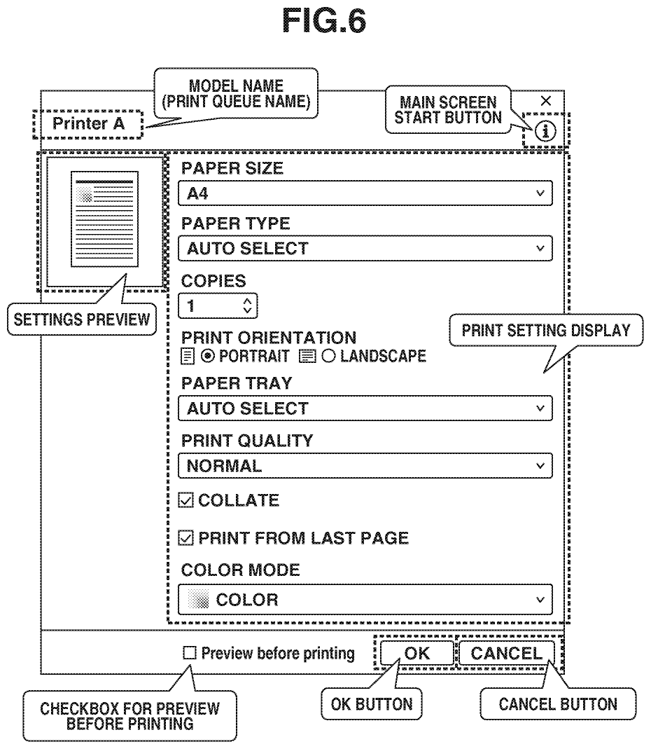

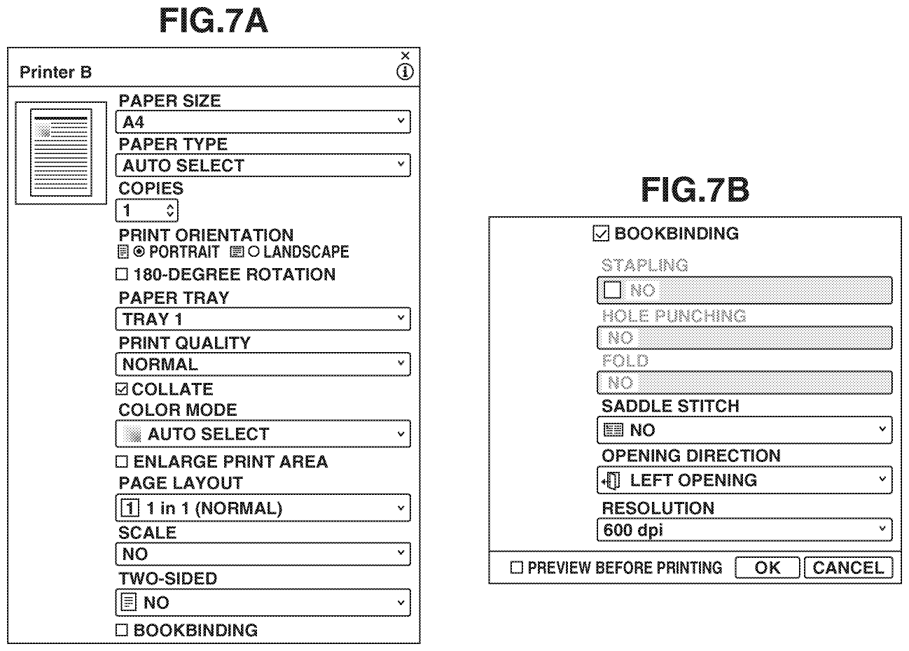

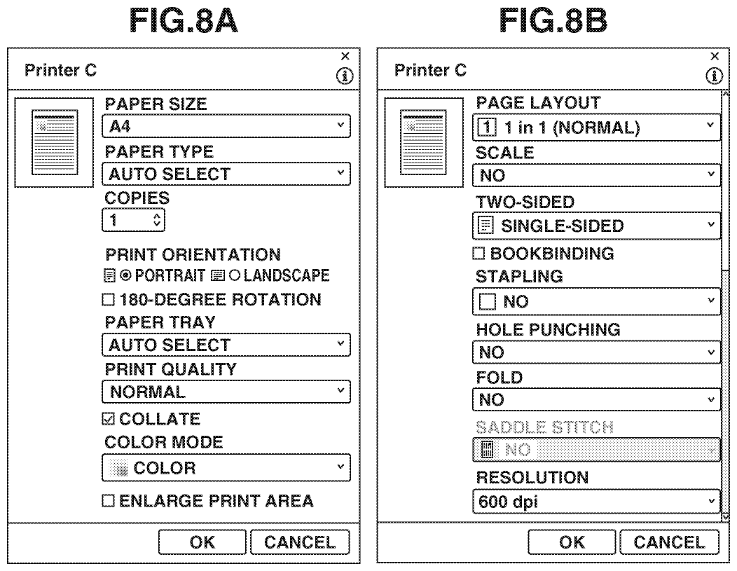

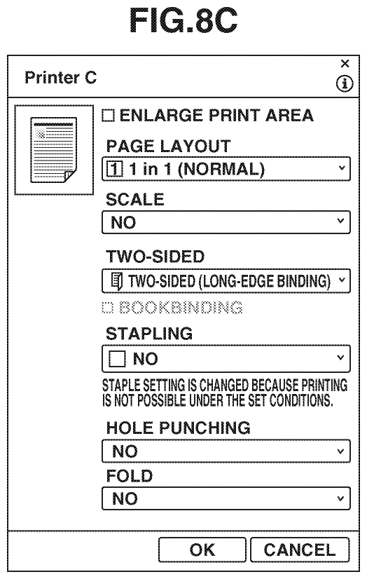

FIG. 6 illustrates a screen configuration of the print setting screen provided by the extension application 204 and descriptions of objects and controls. The print setting screens, such as those illustrated in FIGS. 7A and 7B, and 8A, 8B, and 8C, may be displayed depending on the printing functions, the setting items supported by the printing device 102, and the like.

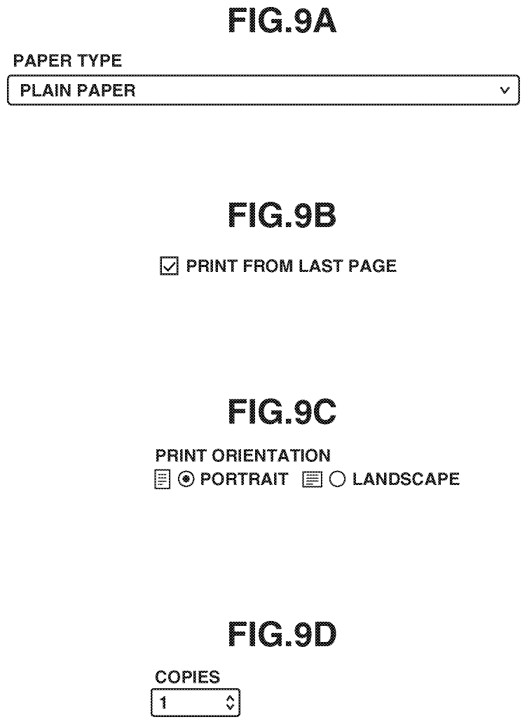

In the print setting display, controls illustrated in FIGS. 9A, 9B, 9C, and 9D are used to configure settings. FIG. 9A illustrates a combo box, and by the user pressing the combo box, a list of configurable values is displayed. The user can select a setting value from this list to change the setting. When the user selects the combo box to open the pull-down list, the pull-down list may be scrollable in a circular manner. This is due to behavior of the OS when the pull-down list includes a large number of items and scrolling is required.

FIG. 9B illustrates a check box, and the on state and the off state of a printing function can be switched by checking or unchecking the check box.

FIG. 9C illustrates radio buttons, and the user can check an option to determine the setting value for the printing function. As illustrated in FIG. 9C, when the user selects the “portrait” radio button for the print orientation, the “landscape” radio button is unchecked (the same applies to the other printing functions).

FIG. 9D illustrates a spin box, and the user can press a button in the spin box to increase or decrease the value. For example, in the case of a spin box for selecting the number of copies to be printed, a desired number of copies can be set. The user can also specify a value by directly entering (a keyboard operation, a touch panel operation, or the like) the value as text.

Returning to FIG. 6, when the user selects the OK button illustrated in FIG. 6, the changes to the print settings configured through the print setting screen are reflected, and the print setting screen is closed.

When the user selects the cancel button illustrated in FIG. 6, the changes to the print settings configured through the print setting screen are discarded, and the print setting screen is closed. Similarly, when the user selects the ×button on the print setting screen to close the print setting screen, the changes to the print settings configured through the print setting screen are discarded.

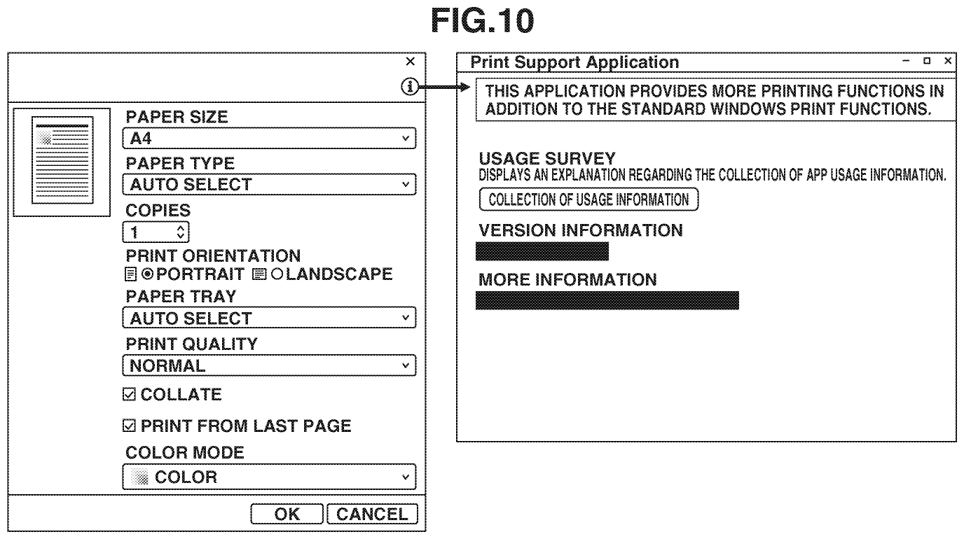

When the user selects the main screen start button illustrated in FIG. 6, the main screen is displayed as illustrated in FIG. 10. The main screen displays, for example, version information about the extension application 204, and a uniform resource locator (URL) for detailed information.

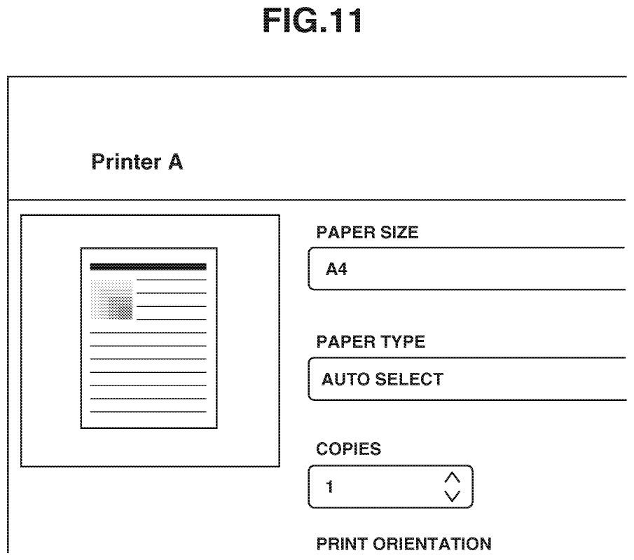

The extension application 204 in the present embodiment displays the model name (the print queue name) of a printing device (to which an image to be printed is to be transmitted) selected by the user as the destination on the print setting screen as illustrated in FIG. 11. If the length of the character string of the model name does not fit within the display area, the characters exceeding the display area are displayed in an abbreviated manner (e.g., “. . . ”).

### Printing Functions and Print Settings Supported by Extension Application 204

The extension application 204 displays on the print setting screen the functions supported (provided) by the connected printing device 102 from among the printing functions supported by the extension application 204. If the connected printing device 102 does not support (provide) a particular function, the function is not displayed.

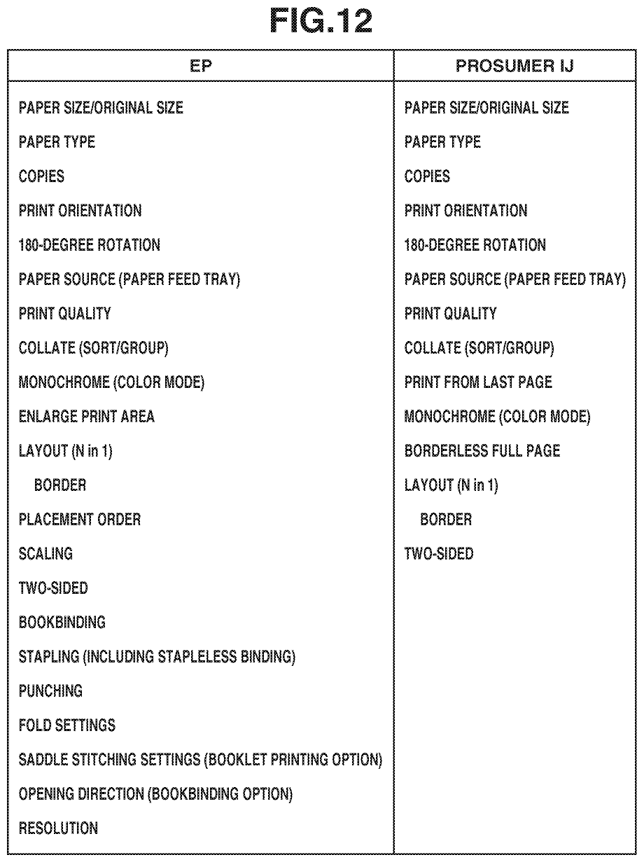

FIG. 12 illustrates the printing functions supported by the extension application 204 and the display order of the printing functions. The names of the printing functions are not limited to those illustrated in FIG. 12 and may be similar names. The display order is also not limited to the order illustrated in FIG. 12.

The extension application 204 displays the functions and the setting items supported (provided) by the connected printing device 102 on the print setting screen. Thus, the extension application 204 determines the supported functions and the setting items that can be set for each function based on the PT and the PC acquired from the print data generation software 202 and the OS to display the print setting screen.

The functions of the print data generation software 202 and the setting items for each function are determined by acquiring capability information from the printing device 102 or the Universal Print service at the time of creating a print queue (a printer queue) and generating a PDC. The available functions and setting items described in the PDC are reflected in the PT and PC.

The extension application 204 adds a printing function to the PDC, which is capability information about the print data generation software 202, so that the printing function is also added to the PT and the PC generated by the print data generation software 202.

If an update to the print data generation software 202 enables support for a function that is not included in the printing functions illustrated in FIG. 12, the function is not displayed on the print setting screen and always operates with the default settings.

Further, if an update to the print data generation software 202 adds a setting item to the printing functions illustrated in FIG. 12, the setting item is added to the print setting screen provided by the extension application 204, and the user can change the setting.

Regarding a folding function, if a printing device is an electrophotographic (EP) printing device, the setting value for “bi-fold” received as a setting value (an option) in the IPP attribute information may result in either bi-folding or saddle folding depending on the printing device. In this case, whether bi-folding or saddle folding is to be performed cannot be determined at the stage of adding to the PDC the setting value for “bi-fold”, so that the print setting screen simply displays the setting value as “bi-fold”.

The display text for the printing functions and the setting items provided by the print data generation software 202 is determined based on the OS specifications. The display text is described as a display name for each function and setting item of the PC, and the print setting screen of the extension application 204 uses the display name as the display text.

The display text of some functions and setting items that are not localized by design is replaced with the resources (the information) stored in the extension application 204 to display. Further, the OS standard text for paper sizes is difficult to understand, so that paper sizes for which the extension application 204 stores resources (information) are replaced with the resources stored in the extension application 204.

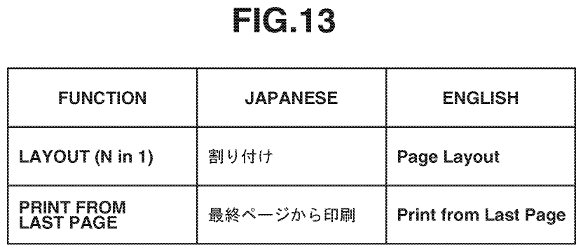

For example, the display text for the printing functions and the setting items illustrated in FIGS. 13, 14, 15A, 15B and 15C, 16A, 16B, and 16C, 17A, 17B, 17C and 17D, and 18 is determined based on the resources (the information) stored in the extension application 204.

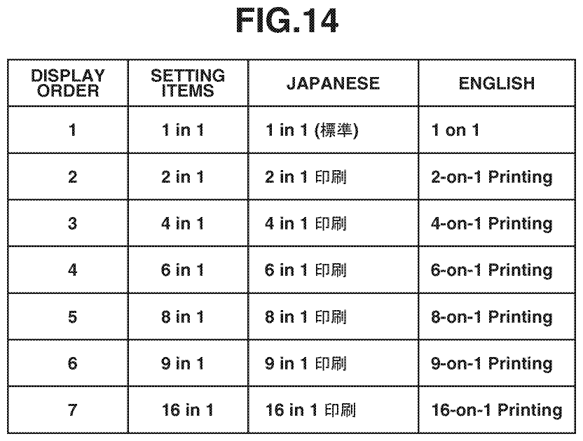

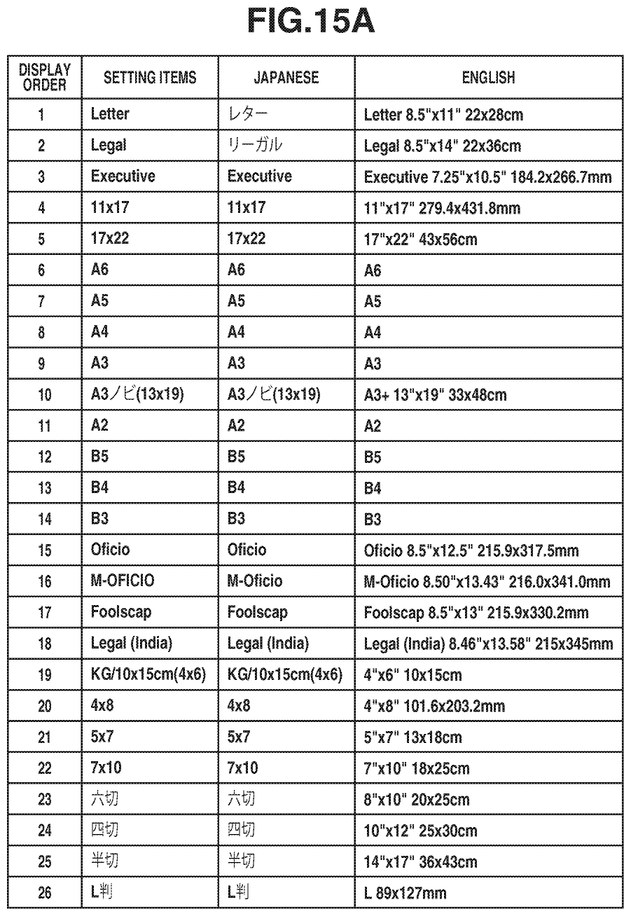

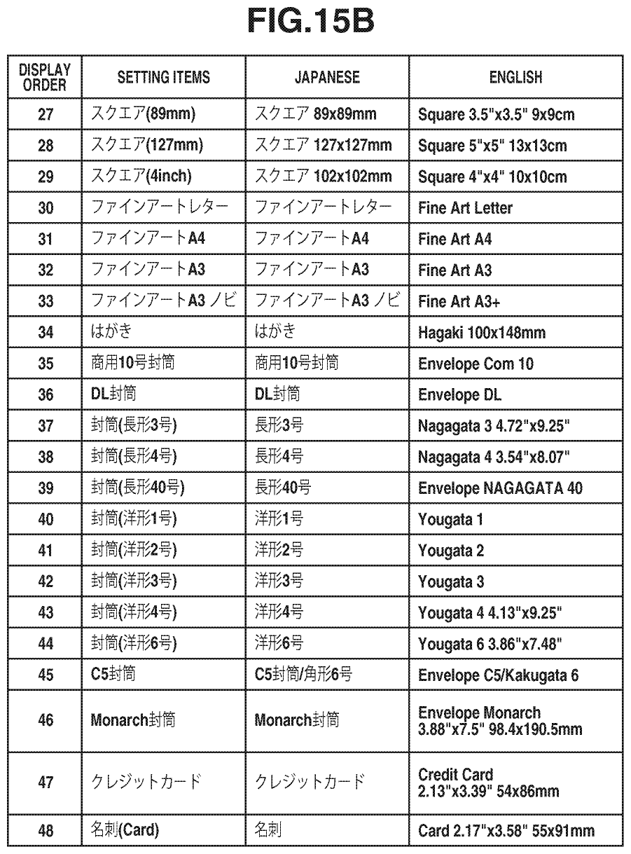

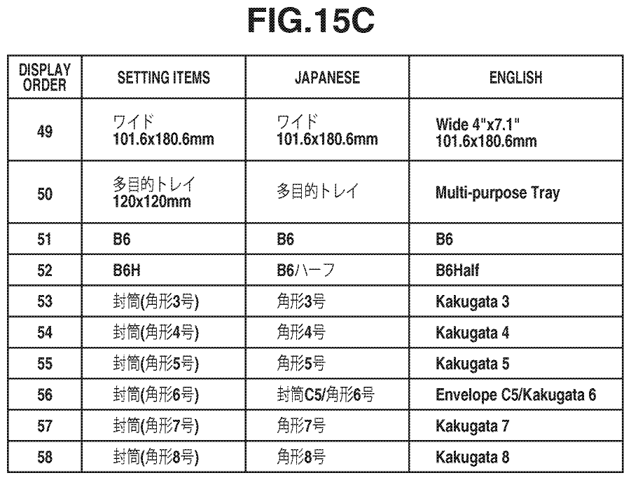

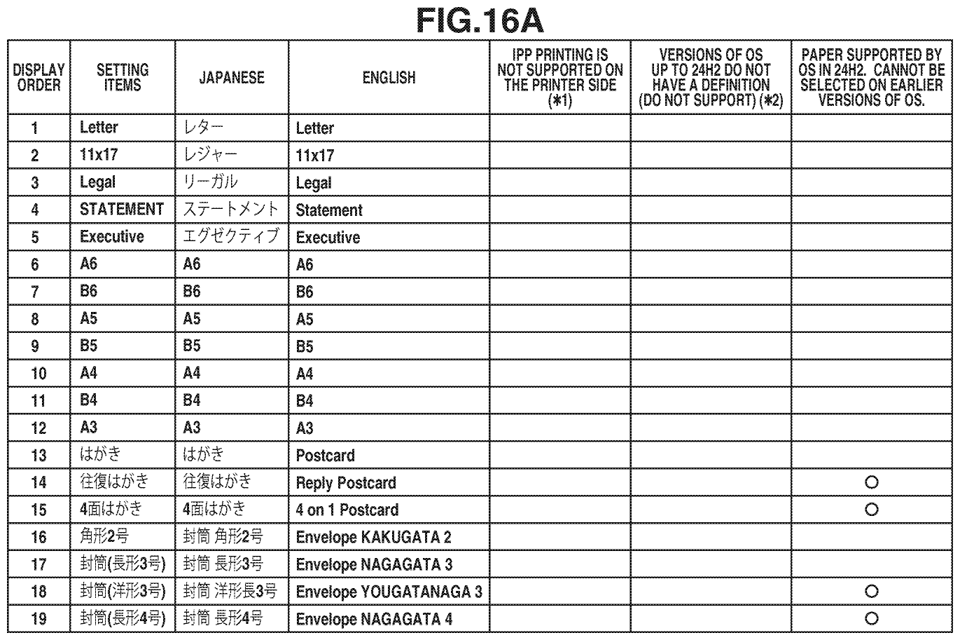

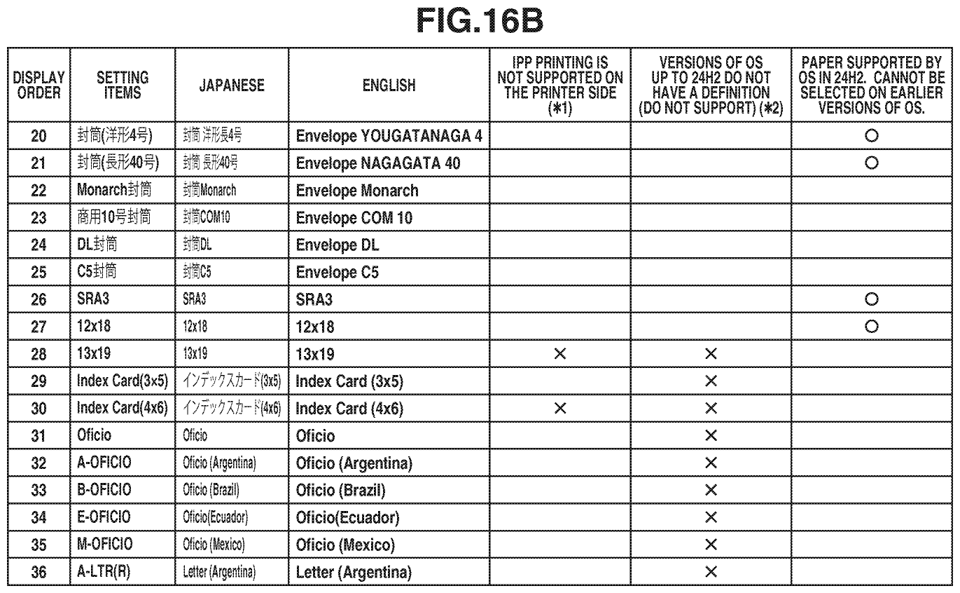

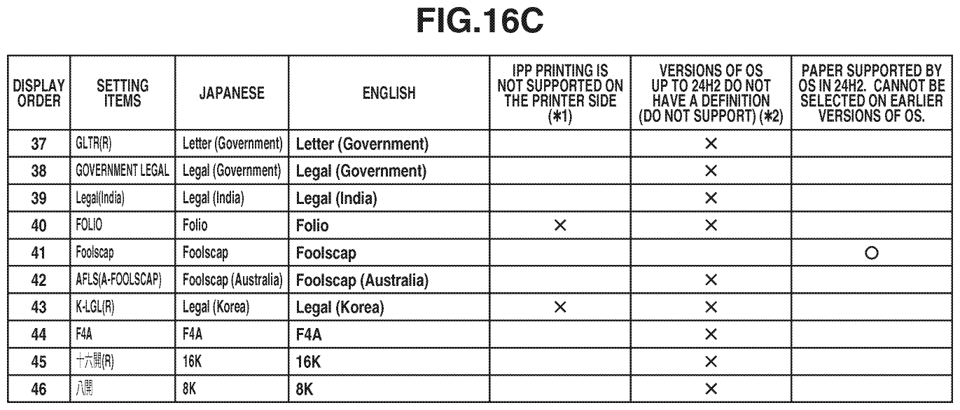

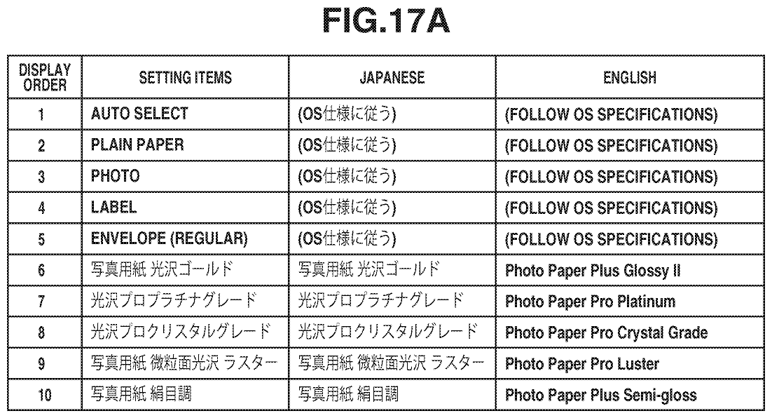

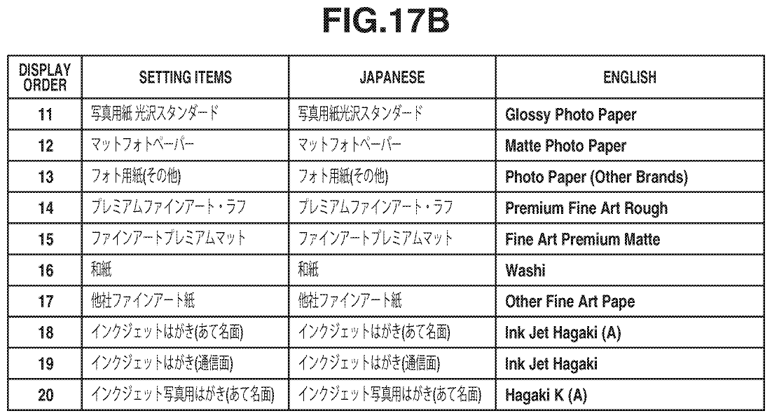

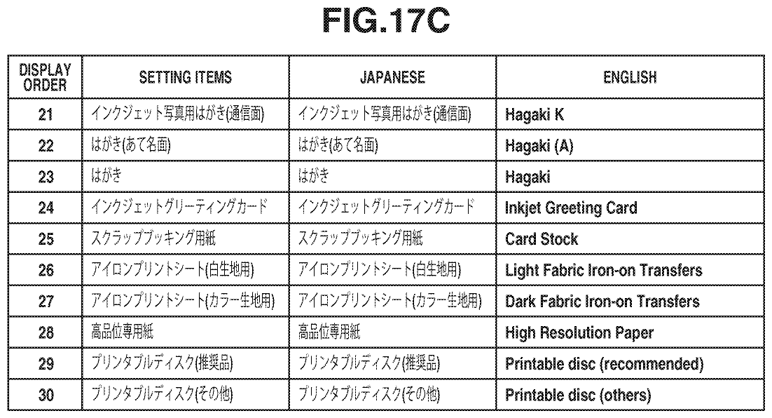

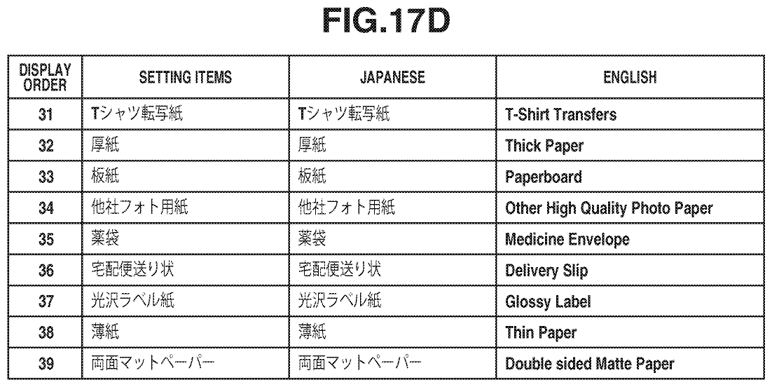

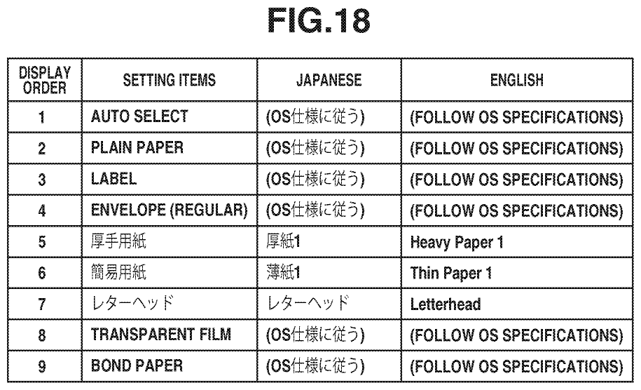

FIG. 13 illustrates printing functions of the extension application 204 in the present embodiment that reference resources (information) stored in the extension application 204. FIG. 14 illustrates setting items (layout printing) and the display order that reference resources (information) stored in the extension application 204. FIGS. 15A to 15C illustrate setting items (paper sizes and document sizes) and the display order that reference resources (information) stored in the extension application 204 with the printing device 102 as a prosumer inkjet printing device (or inkjet printing device). FIGS. 16A to 16C illustrate setting items (paper sizes and document sizes) and the display order that reference resources (information) stored in the extension application 204 with the printing device 102 as an electrophotographic printing device. FIGS. 17A to 17D illustrate setting items (paper types) and the display order that reference resources (information) stored in the extension application 204 with the printing device 102 as a prosumer inkjet printing device. FIG. 18 illustrates setting items (paper types) and the display order that reference resources (information) stored in the extension application 204 with the printing device 102 as an electrophotographic printing device.

The display text stored in the printing device 102 is used for the added paper types. However, in the present embodiment, the extension application 204 is assumed to store the display text list stored in the printing device 102. The display order of the setting items illustrated in FIGS. 13, 14, 15A, 15B and 15C, 16A, 16B, and 16C, 17A, 17B, 17C and 17D, 18 is defined within the extension application 204. In the present embodiment, setting items that are not illustrated in FIGS. 13, 14, 15A, 15B and 15C, 16A, 16B, and 16C, 17A, 17B, 17C and 17D, 18 are provided at the end of the list when displayed on the print setting screen, but the present disclosure is not limited to this.

### Settings Preview

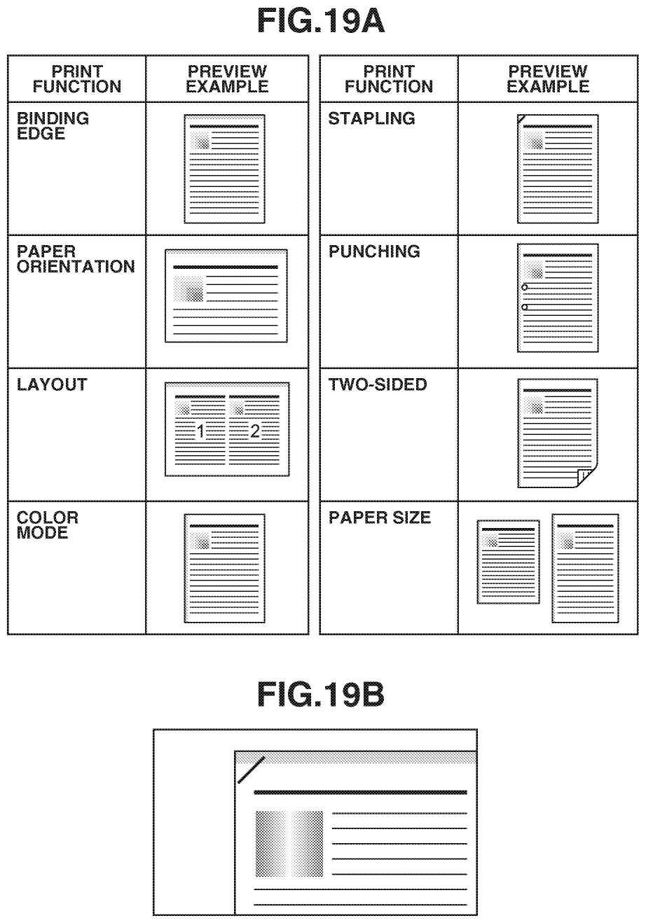

The extension application 204 in the present embodiment displays on the print setting screen previews of output images based on the print settings as illustrated in FIGS. 19A and 19B. The extension application 204 in the present embodiment displays as illustrated in FIG. 19A a setting preview based on the selected setting item (option) when a printing function is changed. The “saddle stitch” setting in the “staple function” is not reflected in the preview. When the user selects “stapleless binding” (eco-staple), a preview image is displayed as illustrated in FIG. 19B.

The preview image of an output image may be an illustration or the like that is stored in advance together with the extension application 204 (i.e., is not based on document data or an image for which an actual print instruction is issued). Alternatively, the document data or the image for which the actual print instruction is issued may be displayed as the preview image.

The technology described in the present disclosure can improve the convenience of an extension application.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-069989, filed Apr. 21, 2025, which is hereby incorporated by reference herein in its entirety.

What is claimed is:

1. A non-transitory computer-readable storage medium storing an application program which causes an information processing apparatus to perform a control method, the application program cooperating with a standard driver, the control method comprising:
acquiring capability information;
displaying a print setting screen configured to receive a print setting from a user;
displaying, on the print setting screen, a first print setting included in the capability information based on information related to the print setting; and
displaying, on the print setting screen, a second print setting included in the capability information based on information stored in advance in the application program.

2. The non-transitory computer-readable storage medium according to claim 1, wherein the capability information indicates a print setting supported by a printing device selected by the user as a transmission for printing.

3. The non-transitory computer-readable storage medium according to claim 2, wherein a type of the printing device is determined based on whether the printing device is an electrophotographic printing device or an inkjet printing device.

4. The non-transitory computer-readable storage medium according to claim 1, wherein the information stored in advance in the application program is information related to paper size, and the second print setting is displayed on the print setting screen based on the information related to the paper size.

5. The non-transitory computer-readable storage medium according to claim 1, wherein the information stored in advance in the application program is information related to paper type, and the second print setting is displayed on the print setting screen based on the information related to the paper type.

6. The non-transitory computer-readable storage medium according to claim 1, wherein printing is performed by a printing device based on the print setting received from the user on the print setting screen and data to be printed.

7. The non-transitory computer-readable storage medium according to claim 1, wherein the capability information is Print Capabilities generated by the standard driver, and the Print Capabilities are generated based on Print Device Capabilities.

8. The non-transitory computer-readable storage medium according to claim 7, wherein the Print Device Capabilities is information based on attribute data acquired by the standard driver from a printing device.

9. The non-transitory computer-readable storage medium according to claim 8, wherein the attribute data is acquired based on the IPP.

10. The non-transitory computer-readable storage medium according to claim 8, wherein the attribute data is acquired in response to issuance of an IPP Get-Printer-Attributes operation to the printing device.

11. The non-transitory computer-readable storage medium according to claim 1, wherein the second print setting is changed depending on whether a printing device selected by the user as the transmission destination for printing is an electrophotographic printing device or an inkjet printing device.

12. The non-transitory computer-readable storage medium according to claim 1, the control method further comprising displaying, on the information processing apparatus, a preview image corresponding to the print setting received from the user via the print setting.

13. The non-transitory computer-readable storage medium according to claim 1, wherein a model name of a printing device which printing is executed is displayed on the print setting screen.

14. The non-transitory computer-readable storage medium according to claim 1, the control method further comprising:
displaying, on the information processing apparatus, an object configured to display detailed information about the application program; and
in response to the user selecting the object, displaying the detailed information.

15. The non-transitory computer-readable storage medium according to claim 1, wherein a display order of either the first setting item or the second setting item is changed depending on a type of the printing device.

16. The non-transitory computer-readable storage medium according to claim 1, wherein the standard driver is a printer driver that generates print data transmissible to a plurality of printing devices.

17. The non-transitory computer-readable storage medium according to claim 1, wherein the standard driver is a standard driver provided by a provider of an operating system of the information processing apparatus.

18. A control method of an information processing apparatus, wherein a standard driver and an application program are installed in the information processing apparatus, the application program cooperating with the standard driver, the control method comprising:
acquiring capability information;
displaying a print setting screen configured to receive a print setting from a user;
displaying, on the print setting screen, a first print setting included in the capability information based on information related to the print setting; and
displaying, on the print setting screen, a second print setting included in the capability information based on information stored in advance in the application program.

19. An information processing apparatus, in which a standard driver and an application program are installed, the application program cooperating with the standard driver, the information processing apparatus comprising at least one processor operating to:
acquire capability information;
display a print setting screen configured to receive a print setting from a user;
display, on the print setting screen, a first print setting included in the capability information based on information related to the print setting; and
display, on the print setting screen, a second print setting included in the capability information based on information stored in advance in the application program.
